(19) United States
(12) Patent Application Publication
(10) Pub. No.: US 2005/0198614 A1
(43) Pub. Date: Sep. 8, 2005

(54) Management platform and evironment

(76) Inventors: Albert Mavashev, Great neck, NY (US); David Mavashev, Glen Head, NY (US)

Correspondence Address: MORGAN, LEWIS & BOCKIUS LLP, 1701 MARKET STREET, PHILADELPHIA, PA, 19103-2921, US

(21) Appl. No.: 09/978,853

(22) Filed: Oct. 16, 2001

(51) Int. Cl. G06F 9/44

(52) U.S. Cl. 717/102

(57) ABSTRACT

A business view including a logic portion that generates a management model based on a publish/subscribe model. The management model includes at least one modeled expert and a plurality of modeled managers and the modeled managers are arranged in an N-tier hierarchy. A graphical user interface (GUI) is provided that displays visual information in response to the logic portion wherein a user can interact with the GUI.

### FIELD OF THE INVENTION

This invention relates to computer programs, and more particularly to manager modeling computer programs.

### BACKGROUND OF THE INVENTION

Management models have been developed to model management tasks, jobs, and decision-making in companies and other organizations using computers. Such management models often utilize a graphical user interface (GUI). Such management models have been often applied to distributed network configurations (including diverse computer platforms and applications) because of the relatively complex and diverse character of managed companies and organizations.

FIG. 1 discloses one embodiment of management model 100. The management model 100 runs on a network of computers such as a personal computer, laptop, server, and/or server. The management model 100 comprises a server 102, at least one agent 104, a graphical user interface (GUI) consult manager 106, and a rules engine 108. The server 102 interfaces with the rule engine 108 to establish the instruction, and passes the instructions to the agent 104 to execute the instruction. The GUI consult manager 106 provides for display of information to, and input of information from, users of the management model. Each agent 104 and server 102 includes a policy 110 that models the agent's or server's view of their professional “world” (i.e., what their job entails).

In many aspects, the computer operation of the management model 100 does not accurately reflect how actual companies or organizations are structured in real life. Computer software, such as Java, has been designed to interface with diverse computer systems. The prior art management models 100 are not designed to, nor adequately meet the demands of, managing the complex middleware environment. In the management model, all transfer of information from each modeled agent is through the modeled server 102. There is therefore no direct collaboration (transfer of information) between any modeled agents 104 without the information initially having passed through the modeled server 102. Lack of agent collaboration, wherein the agents are limited from collaboration with each other, provides a configuration where losing the server 102 that manages the agent(s) results in lack of interaction between any agent and other agents or the server, since all agents interact via the same server. In real world companies, information is often transferred between agents; or between agents and managers who are not directly in charge of that expert. Modeling information as only flowing between multiple agents to a single manager often does not accurately reflect the real world management hierarchy since certain real world employees often report to and/or interface with multiple managers. This limiting the collaboration between agents limits scalability in the management model since it is often useful for agents to act as a source of information for other agents.

There is only one server 104 in the management model 100. Therefore, N-vertical hierarchical levels of human managers in a company or organization can be modeled in the management model 100 as one server 104. Modeling the N-vertical levels of managers in an organization using a single server assumes that all managers follow similar management rules, from the lowest-level manager to the CEO does not accurately reflect the real world management hierarchy since different level managers behave differently. This modeling of all managers as one server also limits scalability in the management model.

It would be desirable to provide a management platform and environment 100 that responds to a need for higher performance management solution that could be deployed quickly for multiple disparate applications and other frequently changing Internet infrastructure elements. It would also be desired to provide management models wherein the agents can be modeled as directly collaborating and directly transferring information. In another aspect, it would be desired to provide a management platform and environment that provides for effective modeling if the modeled management object (e.g., server) for any reason cannot interact with any agent. In another aspect, it would be desired to provide a more flexible management model that more accurately models a real-world corporate or organization hierarchy.

### SUMMARY OF THE INVENTION

The present invention relates to a business view including a logic portion that generates a management model based on a publish/subscribe model. The management model includes at least one modeled expert and a plurality of modeled managers and the modeled managers are arranged in an N-tier hierarchy. A graphical user interface (GUI) is provided that displays the visual information in response to the logic portion wherein a user can interact with the GUI. Different aspects of this invention relate to technology to manage, monitor, and control software components (applications), middleware, application servers and related components.

### BRIEF DESCRIPTION OF THE DRAWINGS

The accompanying drawings, which are incorporated herein and constitute part of this specification, illustrate the presently preferred embodiment of the invention.

FIG. 1 shows a block diagram of a prior art management model;

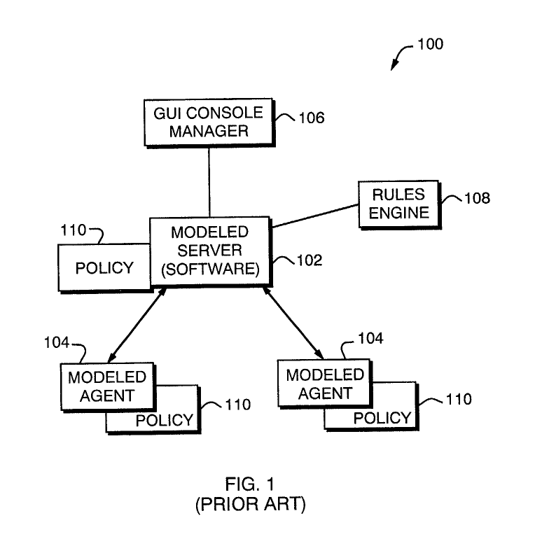

FIG. 2 shows a block diagram of one embodiment of a computer network;

FIG. 3 shows a block diagram of one embodiment of management platform and environment of the present invention such as modeled by the FIG. 2 computer network;

FIG. 4 shows one embodiment of an abstraction of a modeled manager or modeled expert;

FIG. 5 shows one embodiment of a method used to establish a management platform and environment; and

FIG. 6 shows one embodiment of method to build a policy from a business view.

### DETAILED DESCRIPTION OF THE EMBODIMENT

This disclosure describes multiple embodiments of management computer platform and network environment that model company or organization management structure using modeled managers 302 and modeled experts 304. Modeled managers 302 and modeled experts 304 model respective human manager and human expert decision making ability, knowledge, and interaction. Within the management platform and environment 300, by definition, a modeled expert cannot act as a modeled manager and vice versa.

The management platform and environment 300 can be run on a stand-alone computer, a homogenous network, a heterogeneous network, or any such computer or computer network system. However, as real world companies are becoming larger and more complex, and network systems are becoming more integrated, the management platform and environment 300 is most suited for complex, diverse computer networks such as those that run middleware programs.

This disclosure is thus organized to discuss the management platform and environment that is run on a generic network, or stand alone computer. A portion of the disclosure also describes the application of the management platform and environment to middleware applications.

1. Generalized Management Platform and Environment

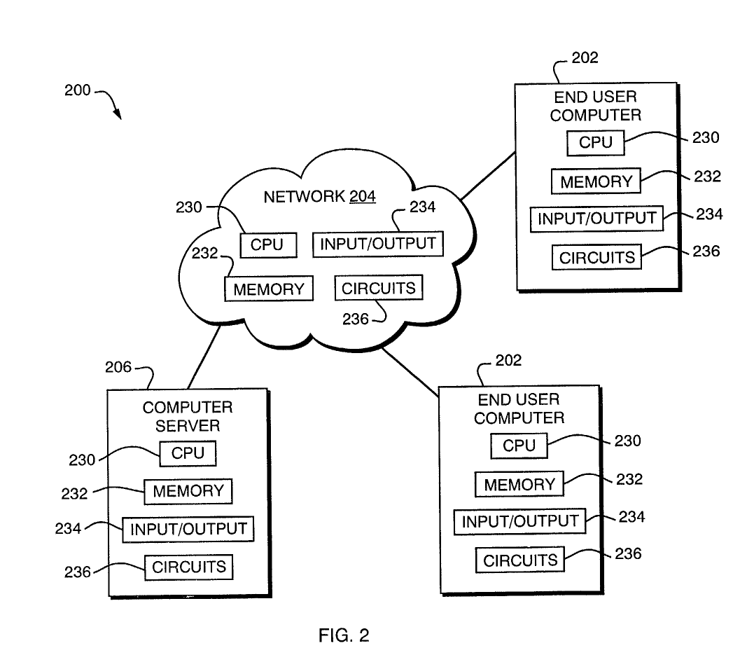

FIG. 2 shows a block diagram of one embodiment of computer network 200 on which a management platform and environment 300 (including a model of a company management) runs. The computer network 200 comprises a plurality of end user computers 202, a network portion 204, and a plurality of computer servers 206 (one is shown). The end user computers 202 are used to display management information as generated by the computer network 200 in response to the user input from the end user computer 202 and data processed from the computer server 206. The network portion 204 consists of multiple switching devices (such as routers, bridges, or switches) and a large variety of computers. As generally known in computer network architecture, computer processing and data storage within the computer network 200 can be performed in one or more of the following: the end user computer 202, the computer server 206, or in some other location within the computer network 200. As such, the following description relating to computer operation within the computer middleware structure 200 describes multiple components (CPU, memory, etc.) that can be located at multiple locations within the computer network 200. These components are therefore indicated at multiple locations with identical reference characters. Though this disclosure describes using a computer network structure to run the management platform and environment, it is envisioned that the management platform and environment 300 can run on a stand-alone computer.

Certain components of the computer network 200 includes a programmable central processing unit (CPU) 230 that is operable with a memory 232, an input/output (I/O) device 234, and such well-known support circuits 236 as power supplies, clocks, caches, displays, and the like. Devices 230, 232, 234, and 236 are each shown in the computer server 206, the network portion 204, and each end user computer 202 since, due to distributed processing and networking techniques, these devices may be located in one or more of these locations. The I/O device receives, for example, electrical signals corresponding to operation of the computer network 200. All of the above elements are coupled to a control system bus to provide for communication between the end user computer 202, the computer server 206, and other external elements within the computer network 200.

The memory 232 contains instructions that the CPU 230 executes to facilitate the processing, storage, transfer, and control of data within the computer network 200. The instructions in the memory 232 are in the form of program code. The program code may conform to any one of a number of different programming languages. For example, the program code can be written in C, C++, BASIC, Pascal, or a number of other languages. Additionally, the computer network 200 can be fashioned as an application-specific integrated circuit (ASIC) to provide for quicker controller speed.

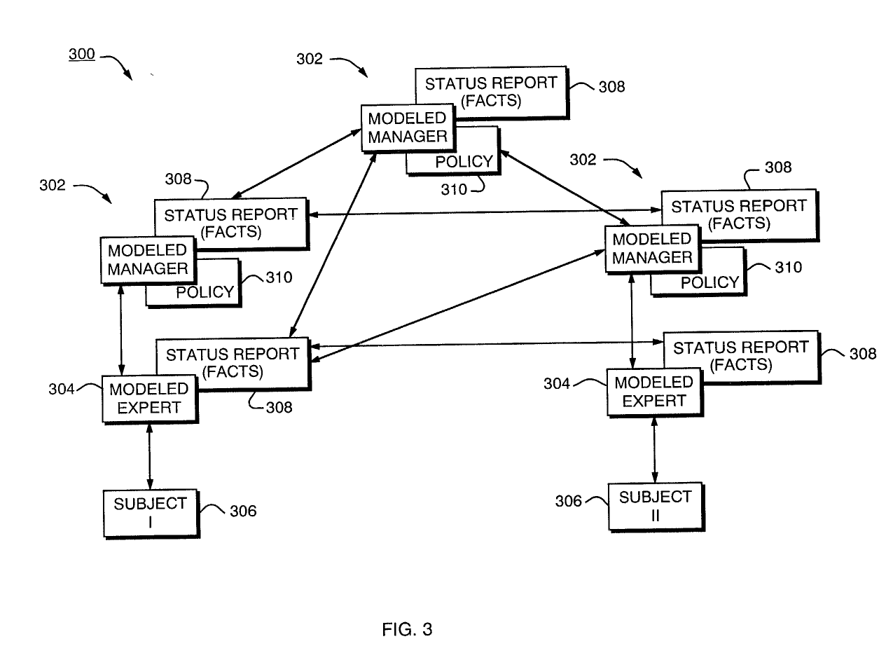

One embodiment of block diagram of a management platform and environment 300 is shown in FIG. 3. The management platform and environment 300 may operate as hardware, software, or a combination thereof on the computer network 200 shown in FIG. 2, or on another embodiment of computer network. The embodiment of management platform and environment 300 provides for collaboration between any modeled managers 302, modeled experts 304, or other models. Modeled managers 302 may be viewed as the software encapsulation of human managers, and are programmed with the logic to mimic decision-making. Modeled experts 304 may be considered as the software encapsulation of human experts, and are programmed with the knowledge (stored in memory locations such as a database) to mimic technical expertise of human experts. After consider use and refinement of their respective software, it is envisioned that modeled managers will more accurately reflect the decision making process of human managers and modeled experts 304 will more accurately mimic the technical knowledge of human experts. The management platform and environment 300 relies on the logical modeling of human managers by modeled managers and of human experts by modeled managers.

The management platform and environment 300 is designed to accurately reflect the flow of information (facts) or the resultant decision-making process and expertise that relies on as interaction that occurs between human management and experts in a corporate environment. The management platform and environment 300 can be rapidly updated to reflect changes in the organization of the company or organization. The management platform and environment 300 also allows for the dynamic control of the management platform and environment to model changes in companies and/or organizations. This allows for the management platform and environment 300 to adapt to changes in the structure of the company or organization that the management platform and environment 300 is modeling. As such, the management platform and environment 300 shown in the embodiment in FIG. 3 more realistically models the management platform and environment since real world companies and organization are constantly changing.

The management platform and environment 300 shown in FIG. 3 includes one or more layers of modeled managers 302 and one layer of modeled experts 304, in addition to a subject 306 that is associated with each modeled expert 304. Each modeled expert 304 has knowledge relating to subjects 306 in their particular areas of expertise. For instance, the modeled expert 304 on the left in FIG. 3 has knowledge about one particular subject while the modeled expert 304 on the right has knowledge about another subject. The subjects of two modeled experts may overlap. Each modeled expert and each modeled manager 302 has their own status report 308.

The status report 308 for each modeled manager 302 and each modeled expert 304 includes facts. Facts are used to determine the relative state as well as operations and decision making characteristics of each modeled managers 302 and/or modeled experts 304. Facts are arranged according to the equation name=value. An example of a fact is state=active. Facts are processed, stored, and transferred within the management platform and environment 300 in this manner. The management platform and environment 300 allows for the facts to be treated differently to different end users depending upon the relation of each end user to those facts. Business Views provide user interpretation of the published facts. Business view provide fact organization, interpretation, visualization, history, as well as automation all in one. Business View are real-time and can be distributed to individual users.

The facts included in the management platform and environment 300 may be as wide or narrow as desired or as programmable. For example, one particular relatively focused management platform and environment 300 may be used to model network management. In such a network, a fact may be that a particular network queue is almost completely filled while the output to the queue is not operating. A suitable decision by a modeled manager may be to increase the output from the queue and/or to limit the input to the queue. Another broader management platform and environment may be concerned with human personnel allocation. A suitable decision by the modeled manager may be to suggest one employee from one location be relocated in another location.

Each modeled manager 302 includes one ore more policies 310. The policy 310 for each modeled manager may be considered that modeled manager's view of the their individual professional job. The modeled experts 304 and the modeled managers 302 can subscribe to the status reports that include facts from other modeled experts and modeled managers status reports 308. The modeled expert 304 and the modeled managers 302 each offer a kind of service. The modeled manager 302 may be considered as a kind of modeled expert 304. The policy 310 may also be considered as a kind of service. Lines having arrowheads are shown in FIG. 3 to indicate examples of which modeled experts and modeled managers can collaborate directly with each other.

Each modeled expert 304 can interface to obtain facts relating to their particular subject 306, and therefore can be considered as having knowledge relating to that particular subject. The modeled experts 304 may be viewed as technicians or non-managing engineers whose positions are primarily technically oriented. The modeled experts 304 can subscribe to other modeled expert's (and in certain cases, other manager's) status report 308, and therefore obtain facts relating to other modeled experts or managers. Additionally, it is envisioned that modeled experts 304 may be able to subscribe to certain portions of certain modeled managers 302 status reports, and therefore obtain limited facts from them. The selection of the particular status reports that each modeled expert or modeled manager can view can be determined on a case by case basis based on the particulars of the management platform and environment 300.

Each modeled manager 302 can subscribe to other modeled experts 304, or other modeled managers 302, of an equal or lower level, status report 308. Modeled managers 302 can subscribe to status reports of all of the modeled experts 304 as well as some of the modeled managers 302. Each modeled manager 304 can be programmed to make decisions based on facts that they possess or are obtained from status reports from other modeled managers or modeled experts.

The modeled managers 302 and the modeled experts 304 can be arranged in an N-tier hierarchy. Each modeled expert 304 is modeled as being at the lowest level of the N-tier hierarchy, and no modeled expert can manage another modeled expert or modeled manager. The N-tier hierarchy of the modeled managers 302 allows for the different levels and different positions of modeled managers 302 to contain different policies 310 and different status reports 308. The N-tier hierarchy allows the management platform and environment 300 to more accurately model human managers of different levels, management styles, and decision making processes than prior management modeling systems. For instance, the modeled manager 302 at the upper level in FIG. 3 may be the CEO of the company that are programmed to follow one set of decision making logic. The modeled managers 302 below the CEO modeled manager may represent or lower level managers that are programmed with another set of decision making logic. As such, the policies 310 of the lower level managers certainly would be different than the policies of the CEO modeled manager.

Similarly, the status reports 308 of the modeled manager representing a lower and middle level manager would be different than the status reports 308 of the modeled manager representing the CEO or CFO. For example, the CEO would be more concerned with major goals of the company. The lower and middle level modeled managers 302 might be more concerned professionally with the day to day operations and interfacing with the modeled experts 304.

In addition, the management platform and environment 300 provides for extensibility between modeled managers, modeled experts and other models. The extensibility is reflected by multiple levels of managers, multiple managers at the same level, and multiple experts at the same level. This reflects actual organizations that have multiple managers and experts arranged at the same level in a N-tier hierarchy.

Object-oriented programming techniques are used to more accurately model the multiple levels and styles of managers in a corporation or organization since each manager or expert is provided with basic common programmed characteristics (e.g. that a certain number of managers or experts who work for a particular manager). Each manager or expert is, however, applied with unique characteristics (e.g., the field of expertise of a modeled expert; or the identities of modeled expert or modeled manager that report to a particular modeled manager). The management platform and environment can also be more response to changing corporate structures since new modeled managers or experts can be quickly added or removed to reflect the actual or desired real world situation. The unified management console of the management platform and environment 300 effectively addresses the complex problems of availability, recoverability, reliability, performance and continuous operation of applications.

One embodiment of the management platform and environment 300 also allows for personalization. This personalization relies upon the concept and interpretation of and conditions could be interpreted differently for different users. For example, assume the fact or data is that certain stock has gone down. This identical data could be interpreted differently by two different users. For one user that is selling long, this data will be interpreted as good news. By comparison, for another user that selling short, this data will be interpreted as a negative. As such, identical facts will be viewed differently by different users. Rationalization provides a view that may be displayed on a graphic user interface.

The architecture of the management platform and environment mimics human management style of human managers and human experts by using distributed modeled managers 302 and modeled experts 304. Information technology modeled managers 302 can use policy-based human instructions to solve virtually all middleware and applications related management problems. Information technology provides an easy means of building interdependency models and personalized information technology using so-called “business views.” The business views 710, in one embodiment, represent a graphical user interface (GUI) implementation. The business views 710 may be accessed online. These personalized, and real-time business views can be made available anywhere and anytime to be used by information technology users and administrators to determine how events and processes influence specific middleware, application and information technology infrastructure.

The management platform and environment may be viewed as a container that includes the entire modeled manager 302/modeled expert 304 hierarchy of a company or organization. The business views 710 technology is easily integrated with virtually all enterprise management platform and environments, since in certain embodiments it can use Java™ and JavaBeans™ (both trademarks of Sun Microsystems) technology. Other container-software middleware programs may also be used to model the management platform and environment 300. One advantage of using embodiments of enterprise management and platform environments using Java/JavaBeans or similar software is that virtually any operating system can run the software associated with the enterprise management platform and environment. The management platform and environment can therefore run on any server-class machine that supports a Java Virtual Machine, including, but not limited to Windows NT, Solaris, AIX, and UNIX. Modeled experts 304 can be developed for any major e-Business applications and management platform and environments including, but not limited to, Web Logic, Oracle 8I, MSMQ, iPlanet, JMS. By adding one or more of these modeled expert 304 modules, management and automation of middleware can be conducted from a single, unified console that is interactively displayed on a GUI.

Enterprise JavaBeans™ provides one embodiment of a container that may be utilized by the management platform and environment 300. Each modeled manager 302 and each modeled expert 304 provides a container. In a real world company, when a human manager builds a company or organization, the human manager can assign one or more human managers or human experts to work for a particular underlying human manager. In a similar manner, a human manager can model the management platform and environment representing their company by modeling one or more modeled managers 302 or modeled experts 304 to report to a modeled manager 302. The superior modeled managers can subscribe to their underling modeled manager and modeled experts status report.

Modeled managers 302 communicate with the modeled experts 304 and other managers to provide the real-time management of the applications and information technology elements with which the modeled experts 304 interface. The N-tier architecture is comprised of the aggregation of the defined modeled managers 302 and their relationship (e.g., dependency) to other modeled managers 302 and modeled experts 304. Modeled managers 302 are mobile experts that filter information using hosted policies. Modeled managers 302 are very much similar to experts except that in certain embodiments, managers are not built to contain (or be able to produce) specific technological information. However, in other embodiments, managers as well as experts can produce technical information.

Modeled managers 302 can manage within the management platform and environment via experts. Each modeled manager 302 maintains a contact list of managed modeled experts 304 and modeled managers 302. Modeled experts 304 and modeled managers 302 within a contact list route facts to their modeled manager 302 for evaluation. As such, the N-tier architecture of the management platform and environment move realistically models the real world management model having multiple tiers of human managers and human experts.

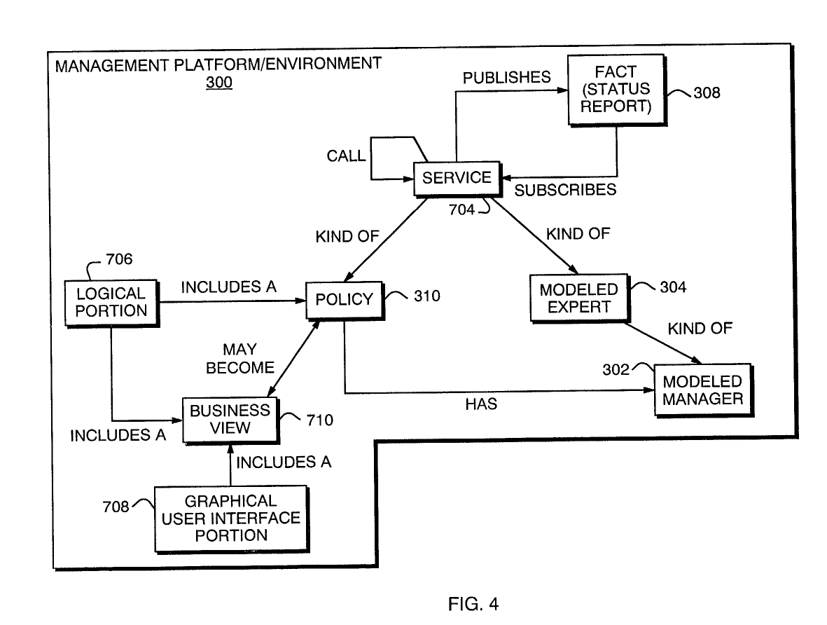

To describe the embodiment of management platform and environment shown in FIG. 3, FIG. 4 shows one embodiment of an abstraction of a management platform and environment 300. The logical interconnections within the management platform and environment 300 are indicated by the arrow including text describing the connections. The components that are included in the management platform and environment that have not been previously described include a service 704, a logical portion 706, a graphical user interface portion 708, and a business view 710. As indicated in FIG. 4, the facts are included in the status report 308. Policies 310, modeled experts 304, and modeled managers 302 are a kind of service 704. The modeled manager 302 is a kind of modeled expert. The status report publishes facts that can be accessed by particular service 704. A service can subscribe to the status report 308 of another service. Both the policy 310 and the business view 710 has its logical portion 706. The business view 710, but not the policy, has its graphical user interface portion 708. The modeled manager 302, but not the modeled expert 304 has its own set of policies 310. In general, any business view may become a policy but not all policies may become a business view.

Abstraction of a manager can be considered as characterizing human management by the modeled managers 302 and characterizing modeled experts 304 in the computer network 200. In one embodiment of the management platform and environment model, each modeled manager 302 or modeled expert 304 can be viewed as being provided with its own policy. Using object oriented techniques, the object “policy” is a service that can be accessed by other objects such as the modeled expert and modeled manager. Each policy therefore has common aspects but can be suitably modified depending on what is added to the inherited base policy class for each policy.

Human managers can use the management platform and environment as a tool to take corrective action. A modeled manager 302 can be configured within the management platform and environment, to act as a manager of either another modeled manager or modeled expert. The management platform and environment applies the FIG. 4 abstraction of modeled manager/modeled expert to software and hardware systems of the computer network 200. In the management platform and environment 300, modeled managers are mobile, autonomous, and can provide multiple business views 710 and policies 310. Additionally, a modeled manager can subscribe to certain facts relating to modeled experts 304 or modeled managers that are lower or equal on a hierarchical chart.

Business views 710 are dynamic interdependent models of various objects in the management platform and environment 300. The business view 710 includes a visual portion and a logical portion. The visual portion of the business view 710 is considered what can be displayed on a computer display, e.g., a graphical user interface (GUI). The logical portion is considered the logic generally provided by the interaction between the CPU 230 and the memory 232 in the computer network 200. Business views 710 provide correlation, evaluation, and interdependency between various facts provided by modeled experts, policies and/or modeled managers within the computer network 200. Business views 710 correlate information from various applications to provide a current unified “health” view of any management platform and environment.

Business views 710 provide a continuously updateable (real-time) as well as historical GUI process that display output from, and receive input for, the management platform and environment 300. A benefit of the management platform and environment is that they are self-contained. As such, the entire management platform and environment model could possibly be modeled as a single expert (more realistically for smaller companies or organizations). The personal aspect relates to the ability to provide a personal view specifically to one own need by iterative processes. Alternatively, certain of the employees can be modeled as modeled managers 302. The management platform and environment thus can be used to model a management infrastructure as desired. In a similar manner, the modeler of the business view 710 can assign a manager to monitor one or more managers or experts in the business view.

Following review of the operation of the business view 710, the human manager can evaluate the business view 710 and its associated facts to determine if it accurately reflects the actual or desired business situation. If it is determined that the business view 710 is not acceptable, than the business view is suitably modified or abandoned by a human manager or programmer before it matures into a policy. When a human manager or programmer determines that the business view 710 is performing acceptably (i.e., the management platform and environment accurately models the facts and decisions of the modeled real world company organization), then the user can run the business view 710 in the background as a fully functioning policy. The policy can be equated as a closed container since they are not to be changed by other human managers or human experts accessing the management platform and environment 300. Certain employees then can use the management platform environment including the policy without considering the particulars of the model. When a human manager or expert goes home or is absent, the policy developed by the business view 710 can operate, and provide input consistent with the general knowledge, management techniques, and skills of the human manager or expert independently from the human manager or expert.

Business views 710 can be saved and loaded at any time. The policy may be viewed as the modeled manager's 302 view of the world. The view of the world will be delineated by the set of policies, the set of policies reflect the accuracy by which the business view 710 of the world is being modeled. In addition to the policy, each modeled expert 304 or modeled manager 302 is provided with a status report. Each policy contains it's own status report. The status report is read by whoever needs to know or is interested in the modeled manager's 302 or modeled expert's 304 job status. The status report permits interaction between different modeled managers 302 or modeled experts 304 in the management platform and environment. For example, a modeled manager 302 or modeled expert 304 can receive instructions from a modeled manager 302. The modeled expert 304 will execute the instruction. Either the modeled manager 302 or modeled expert 304 has or has not completed each instruction, and this fact will be detailed in the status report.

Business views 710 can be used for notification and automation. The embodiment of computer network 200 shown in FIG. 2 is capable of receiving input from hardware in the form of sensors and/or meters for monitoring parameters. A sensor is considered to be an interpretation of a fact. Every time a fact is defined, it may be considered a sensor. Business views 710 can also be used to view facts and to assign meaning and correlate various facts in one single business view 710 or policy.

Every time a fact is defined, a new “sensor” is created. Sensors define what is an interpretation of a fact. Each business view 710 or policy consists of sensors organized in a tree hierarchy. Each sensor evaluates its facts and inputs (other sensors) and produces a single severity. Once a sensor is evaluated to a severity, end users may get a notification or run an action.

The GUI of the management platform and environment presents users with a substantially uniform appearance across all modeled experts 304 and software management. The uniform interface is intuitive and should be object-oriented since object oriented programs are especially useful in providing uniform interactive GUI environments. The management platform and environment provides high speed and secure configuration and administration capabilities. The GUI enables users to securely view and access management, node structures and facts, amend or build modeled manager policies, or issue commands.

The management platform and environment 300 can send events, such as alarms and status changes, to the user interface or virtually any computer network or enterprise management system. The management platform and environment 300 has the ability, through bi-directional interfaces, to communicate with (and be updated by) the information technology infrastructure for real-time problem resolution and performance optimization relating to corporate management. This “self-healing” management platform and environment allows information technology managers to proactively correct problems before normal operations are impacted.

Modeled experts 304 can be considered as mobile experts that provide a fully bi-directional interface with selected applications and network devices within the computer network 200. Modeled experts 304 are preferably non-intrusive. In one embodiment, modeled experts are programmed as JavaBeans™ applets that have the ability to “wrap around” other applications. The modeled experts of the management platform/application 300 are therefore allowed to access their core functions and data. Modeled experts 304 monitor and collect the detailed configuration, historical performance and real-time information about the operational state of the underlying application or network devices. The modeled experts 304 publish facts that represent the current run-time value/state of an object within an application or information technology element.

Deployment of the management platform and environment includes creating modeled experts 304, modeled managers 302 and policies within the suitable managed nodes. Once deployed, these components can then be enabled to perform specific tasks. When deployed a copy of the component can be sent across the network portion to the managed node, or other nodes, to be utilized.

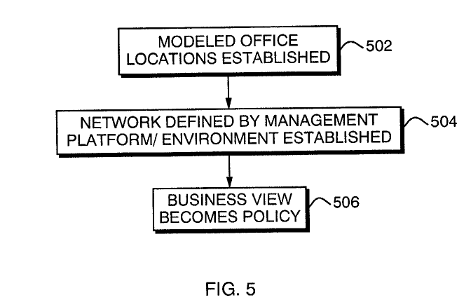

FIG. 5 shows one embodiment of a method 500 to establish a management platform and environment. To establish a management platform and environment network, the software office locations are established in step 502. The modeled offices may be defined as different locations, and each location may include one or more managers or experts. The modeled locations of the modeled offices (i.e., an existing modeled office, or certain managers/experts in a modeled office in one location may be applied to another office location in another location), and their modeled experts and modeled managers may correspond to the respective location of the physical offices, the human experts, and the human managers. Alternatively, if it is desired to apply expertise from one location to another, then the modeled experts and/or the modeled managers can be “moved” or “copied” to another modeled office location as desired. Additionally, a modeled manager or modeled manager can be located in the modeled office corresponding to the actual office in which the respective human manager or the human expert is located. The modeled manager or modeled expert can be virtually located at a modeled office (and can be modified as appropriate for the modeled office) at the same time as, or at a different time than, when the respective human manager or human expert is physically located at their actual office.

In step 504, the computer network 200 defined by the management platform and environment may be further be established by inserting the facts onto the computer server 206 as shown in FIG. 2. The facts include, e.g., the services that are available in that the domain server. The facts are established in the container. All of the facts can be contained in a single container, or the facts can be subdivided between multiple containers. Management platform and environment provides a loosely coupled autonomous self-contained with collaboration model based on publishing/subscribe model.

In step 506, the business view 710 becomes a policy 310. This occurs after a human manager determines that the facts of the business view 710 accurately reflect the actual or desired situation. In this aspect, a visual policy engine looks at the operation of the system, plans, and then deploys the business view 710 to become the policy 310. There may be a plurality of object collaboration models. For example, take a date element that these pick up, and produce. In the worse case method, collect real data, turn the real data into meaningful data before it is conveyed. Acts are examples of objects. In step 506 the acts are converted into objects. Multiple mobile expert technologies may be provided.

The management platform and environment provides for peer to peer, as well as hierarchical communications between different modeled experts 304 and modeled managers 302. Their independent modeled managers 302, when automated, provide the structure of the management platform/environment. It is important to build the organization and then describe the elements of the organization. The elements of the organization include the business views 710, which dependencies are described. Dependencies describe the relations between the elements.

Each modeled manager 302 includes polices. Polices define the responsibilities of each manager. The business that can be deployed is one policy of the modeled manager 302. The modeled manager 302 will enforce on behalf of the human manager each policy that is independent of the management platform and environment. The policies are then built. Every business view 710 is a policy 310, however every policy is not necessarily a business view. Note that the business view 710 includes the visual plus logical aspects (e.g. software) of the modeling. The policy includes only the logic aspects of the model. For example, the business view 710 includes a display aspect that may utilize the GUI. The logical aspects of the business view 710 include the rules plus the action. Every policy 310 can be stateful and/or stateless (same as for the business view 710). Once a policy 310 becomes a business view 710, it can always be either a policy and/or a business view. If a policy 310 is created, the policy does not necessarily become a business view 710.

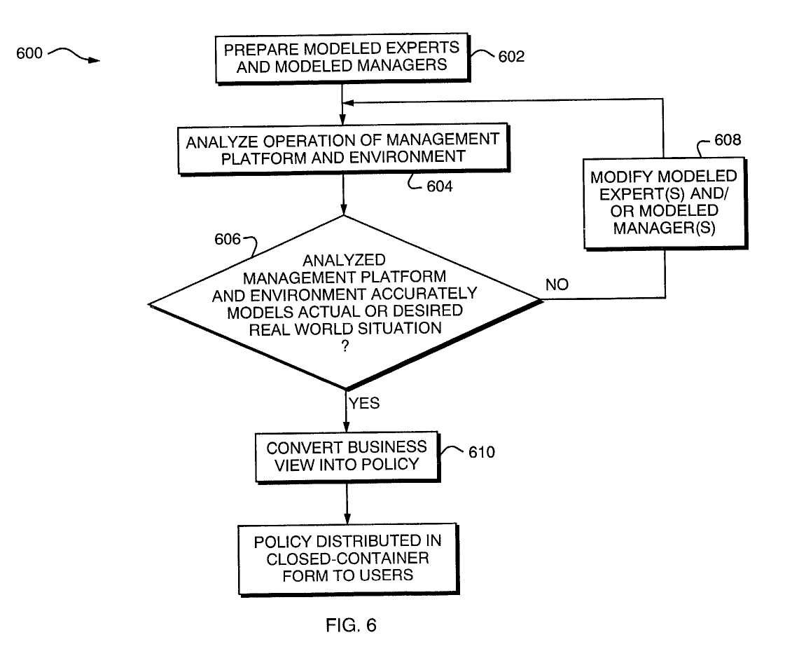

FIG. 6 shows one embodiment of method 600 that can be used to build a policy from a business view. The method 600 starts by preparing the business view management platform and environment in step 602 by programming the modeled expert and modeled experts. Previously prepared modeled managers or modeled experts can be prepared by copying and editing existing respective modeled managers or modeled experts from other office locations, or alternatively programming the respective modeled managers or modeled experts from scratch.

The method 600 continues to block 604 in which the operation of the management platform and environment is analyzed. This analysis can be performed by interacting by a human manager interacting with the business view using real world or simulated situations. Alternatively, a programmed tester can be utilized wherein management situations are input to the business view of the management platform and environment to determine whether the response is suitable. The method 600 continues to decision step 606 in which it is determined whether the analyzed operation of the management platform and environment accurately models an actual or desired real world situation. If the answer to decision step 606 is no, the method 600 continues to step 608 in which the programmed code of the business view, characterized by the modeled experts and modeled managers, are reprogrammed to make the business view more realistic. Following step 608, the method continues to step 604.

By comparison, if the answer to decision step 606 is yes, then the method 600 continues to step 610 in which the business view is converted to a policy. The policy then can be distributed, as indicated in step 612, in a closed container form to end users. Since the policy is in a closed container form, each user can be granted access to selected information based on that user need to interact with distinct portions of the management tool and environment.

If it is desired to convert the policy back to a business view to allow for interaction and modification by a human manager, that can be accomplished as desired.

The management platform and environment 300 that runs on the computer network 200 includes a decision support system. The decision support system may be included in certain embodiments of management platform and environment, and is designed to monitor, store and display any event information generated by the computer network 200. The decision support system provides a graphical display that is Windows-based, and therefore permits quick Web deployment. The information may be presented in the form of user definable charts that can be viewed and printed in real-time or at a later time. The decision support system writes the information to any ODBC-based database or to a flat file enabling capacity planning and statistical analysis using existing tools.

In addition to providing the required management, administration, performance, and monitoring functionality, the integrated middleware management solution included within certain embodiments of the computer network 200 empowers the information technology and business units to automatically detect, correct, control, and optimize middleware operation. Monitoring tools are available for networks, entire legacy enterprises and selected servers, but few solutions exist for middleware applications.

This disclosure has described the application of the management platform and environment 300 to a generalized computer network 300. Now, the management platform and environment 300 is described as being applied to the embodiment of middleware network. Middleware is a type of computer software that mediates between the large variety of hardware and software found in large heterogeneous computer networks. For example, in a large heterogeneous computer network, a single application program, such as a billing program, may utilize (i.e. call upon) software modules supplied by a dozen different suppliers, whose products may or may not be compatible. The middleware network 700 is especially applicable to running so-called e-business or e-commerce applications.

In the preferred embodiment, the management platform and environment 300 is developed in Java in a distributed, policy-based management, software-based program. The management platform and environment 300 provides management that consolidates and correlates management data from multiple applications, middleware, information technology elements, and underlying systems.

The computer network 200 is provided with a high availability queuing services top control the queuing and data flow between the different devices in the computer network. The high availability queuing services is a queuing manager within the management platform and environment 300 that captures application data so that it can be applied to a rules correlation engine. In one embodiment, high availability queuing services captures data from any application compatible with MQSeries (MQSeries is a middleware software program produced by International Business Machines). MQSeries allows business process re-routing decisions—quickly and efficiently. High availability queuing services allows users to proactively monitor the applications as well as guard those applications against failures and increase their availability. High availability queuing services also adds non-intrusive queue failure and recovery services for existing applications.

A console may be provided as a front-end application for single-point monitoring of events and issuing of commands using a graphical user interface (GUI) for Windows systems. Certain embodiments of the computer network provide one or more of: a central console for remote access commands, handling of predefined user actions, backing up and recovering configuration, independence from MQSeries channels with respect to operation, uniform user interface across all the operating systems used in the network, execution of scripts from a central location, and archiving of command history.

The GUI may be provided for the management of MQSeries. MQControl (produced by the assignee of the present invention) provides one embodiment of intuitive graphical user interface (GUI) that can be used for administrating, application developing, and system managing the ability to perform centralized configuration, administration, operation, monitoring, performance tuning for MQSeries network. Required MQSeries optimization management tasks can be performed from a central display. MQControl can automatically discover new MQSeries nodes anywhere in the network portion 204. Users can create, configure and modify MQSeries objects, including queues, queue managers, channels and processes, as well as MQControl objects, including groups and group managers.

Decision support system provides the user with statistics related to the queues and channels defined in their MQControl environment. The statistics related to the queues and channels defined in their MQControl environment. The statistics allow the user to monitor activity and make decisions on how to define the queues and channels and make intelligent decisions based on the information provided.

Decision support system for MQSeries monitors selected channels at an interval specified by the user. The data is written to a file, an SQL-based database, or both. The data consist of a count of the total bytes sent from the selected channel, a count of the total bytes received by the selected channel and a count of the total messages processed by the selected channel. The decision support system also monitors selected queues at an interval specified by the user. The data consist of a count of the ENQueued messages for a specific queue, a count of the DEQueued messages for a specific queue and the depth of the selected Queue.

Message Management Facility (MMF) is a comprehensive message management solution that helps locate any message anywhere on the computer network 200. Together with MQControl, MMF provides administrators with the ability to take full control of every message on the computer network. Messages can be browsed, edited, copied, moved or deleted by authorized personnel. MMF can also be used in training, testing and prototyping of MQSeries application development.

MQEvent Publisher lets the operator of the management platform and environment 300 publish events to multiple subscribers and allows you to deliver an uninterrupted stream of MQSeries system information, notify users of messages on Dead Letter Queues and forward application-generated events to multiple Enterprise Management Systems or any process.

Working with MQControl, WebMQ takes MQSeries network information, converts it into standard, web-accessible HTML and presents it in a familiar browser-type interface. WebMQ also lets users perform key maintenance tasks, such as monitoring events, starting and stopping objects, clearing queues and recovering channels.

While the principles of the invention have been described above in connection with the specific apparatus and associated method, it is to be clearly understood that this description is made only by way of example and not as a limitation on the scope of the invention.

1. A business view comprising:
a logic portion that generates a management model based on a publish/subscribe model, the management model includes at least one modeled expert and a plurality of modeled managers, the modeled managers are arranged in an N-tier hierarchy; and
a graphical user interface (GUI) that displays visual information in response to the logic portion wherein a user can interact with the GUI.

2. The business view of claim 1, wherein the logic portion can solve problems automatically.

3. The business view of claim 1, wherein the modeled expert comprises a plurality of modeled experts that are configured to collaborate.

4. The business view of claim 1, wherein the modeled managers are developed in another location, and transferred to the logic portion.

5. The business view of claim 3, wherein collaboration is permitted between a plurality of software experts.

6. The business view of claim 3, wherein the at least one modeled manager comprises a plurality of modeled managers that are arranged in a vertical hierarchy.

7. The business view of claim 3, wherein each modeled manager and each modeled expert include a status report that contains facts.

8. The business view of claim 3, wherein each modeled manager and each modeled expert includes zero or more policies.

9. The business view of claim 1, wherein the software experts and modeled managers are loosely coupled across the network.

10. The business view of claim 1, wherein the business view is scalable. May monitor thousands and thousands of elements without explicit definition of each managed element.

11. The business view of claim 1, wherein the business view is capable of maturing into a policy.

12. A business view comprising:
a logic portion that includes zero or more one software expert and/or zero or more modeled manager arranged in an N-tier architecture, the logic portion can generate a management model based on a publish/subscribe model, wherein collaboration is permitted between a plurality of software experts; wherein the software experts and modeled managers are loosely coupled; wherein the at least one modeled manager comprises a plurality of modeled managers that are arranged in a vertical hierarchy; and wherein each modeled manager and each modeled expert includes a status report that includes facts; and
a graphical user interface (GUI) that displays visual information in response to the logic portion wherein a user can interact with the GUI.

13. The business view of claim 12, wherein the logic portion can solve problems automatically.

14. The business view of claim 12, wherein the modeled managers are developed in another location, and transferred to the logic portion.

15. The business view of claim 12, wherein each modeled manager includes zero or more policies.

16. The business view of claim 12, wherein the business view is scalable.

17. The business view of claim 12, wherein the business view is capable of maturing into a policy.

18. A policy comprising:
a logic portion that includes at least one software expert and at least one modeled manager arranged in an N-tier architecture, the logic portion can generate a management model based on a publish/subscribe model, wherein each modeled manager and each modeled expert includes a status report that includes facts, wherein collaboration is permitted between a plurality of software experts; wherein the software experts and modeled managers are loosely coupled; and wherein the at least one modeled manager comprises a plurality of modeled managers that are arranged in a vertical hierarchy.

19. A management platform and environment comprising:
a graphical user interface (GUI) that displays visual information wherein a user can interact with the GUI, wherein the GUI displays a plurality of modeled managers and at least one modeled expert arranged in an N-tier architecture, at least two of the modeled managers are arranged in a vertical hierarchy.

20. The management platform and environment of claim 19, wherein each modeled manager and each modeled expert includes a status report, the status report includes facts.

21. The management platform and environment of claim 19, further comprising a logic portion, wherein the GUI displays the visual information in response to the logic portion.

22. The management platform and environment of claim 21, wherein the logic portion includes a management model.

23. The management platform and environment of claim 21, wherein the logic portion is based on a publish/subscribe model.

24. The management platform and environment of claim 21, wherein the logic portion is scalable.

25. A method of converting a business view into a policy comprising:
providing the business view including a logical portion and a graphical user interface (GUI) portion, the GUI portion displays visual information wherein a user can interact with the GUI;
analyzing the logical portion of the business view portion using the GUI portion to determine whether the business view accurately models an actual or desired real world situation; and
converting the business view into a policy if the business view does accurately model the actual or desired real world situation.

26. The method of converting a business view into a policy of claim 25, wherein if based on the analyzing step it is determined that the business view does not accurately model the actual or desired real world situation, further comprising:
modifying the business view using the GUI portion; and
re-analyzing the logical portion of the business view portion using the GUI portion to determine whether the business view accurately models an actual or desired real world situation.
